(19) United States
(12) Patent Application Publication
(10) Pub. No.: US 2016/0232600 A1
(43) Pub. Date: Aug. 11, 2016

(54) One-Click Checkout Apparatuses, Systems, and Methods

(71) Applicant: Visa International Service Association, San Francisco, CA (US)

(72) Inventor: Thomas Purves, San Francisco, CA (US)

(21) Appl. No.: 15/017,969

(22) Filed: Feb. 8, 2016

Related U.S. Application Data
(60) Provisional application No. 62/113,518, filed on Feb. 8, 2015.

(51) Int. Cl. G06Q 30/06; G06Q 20/22; G06Q 20/12

(52) U.S. Cl. CPC G06Q 30/0641; G06Q 20/12; G06Q 20/22

(57) ABSTRACT

The One-Click Checkout system (“OCC”) generates dynamic checkout user interfaces with improved checkout success rates. This may be achieved via receiving, by a merchant client (e.g., app or web site), a user input that reflects a user interest in engaging in a payment transaction with the merchant. The merchant client may retrieve persisted information associated with a suggested payment method registered with a payment service provider. The merchant client may transmit at least a portion of the persisted information and transaction information to the payment service provider server, and receive one or more responses that include a risk indicator and payment-service-provider information associated with the suggested payment method. If the risk assessment is acceptable, the merchant client may generate a user interface that includes a representation of the suggested payment method using information selected from one or both of the persisted information and payment-service-provider information.

### PRIORITY

This application claims priority to U.S. Patent Application Ser. No. 62/113,518, filed Feb. 8, 2015 and entitled “One-Click Checkout Apparatuses, Systems, and Methods.” The entire contents of the aforementioned application is expressly incorporated by reference herein.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally relates to e-commerce, and more specifically to payment user interfaces used in e-commerce.

### BACKGROUND

Merchant web sites and mobile device apps commonly store customers' payment method information, such as credit card numbers, in order to give repeat customers the option to use the stored payment method to complete new transactions. A customer whose payment method information has been persisted by a merchant may thus use the stored information and need not enter it again. However, one shortcoming of this practice is that the stored payment method information may become obsolete (e.g., when a credit card's expiration date passes). Moreover, a user wishing to update his payment method information may have to do so with every merchant that has a copy of the information. Therefore, a need exists to improve the way in which merchants persist and use customers' payment method information.

### SUMMARY

In accordance with the teachings provided herein, systems, methods, apparatuses, non-transitory computer-readable medium for operation upon data processing devices are provided to 1. For example, a computer-implemented method is disclosed for generating a payment user interface that includes receiving, by a computer system operating in accordance with instructions associated with a merchant, a user input. The computer system determines that the user input reflects a user interest to engage in a payment transaction with the merchant and further determines a suggested payment method. The suggested payment method is one of the one or more user payment methods registered with the merchant. The computer system retrieves persisted information associated with the suggested payment method. The persisted information is stored locally on the computer system or remotely on a server associated with the merchant. The computer system determines that the suggested payment method is registered with a payment service provider and transmits to a server associated with the payment service provider at least a portion of the persisted information and transaction information associated with the payment transaction. The computer system receives from the server one or more responses, which include a risk indicator and payment-service-provider information associated with the suggested payment method. A user interface is generated that includes a representation of the suggested payment method using information selected from one or both of the persisted information and the payment-service-provider information, if the risk assessment is determined to be acceptable.

### BRIEF DESCRIPTION OF THE DRAWINGS

The accompanying appendices and/or drawings illustrate various non-limiting, example, innovative aspects of the One-Click Checkout (hereinafter “OCC”) system in accordance with the present descriptions:

FIGS. 1A-1C show block diagrams illustrating example embodiments of the OCC;

FIGS. 2A-2C depict screen shots of exemplary user interfaces for creating a new account with the OCC and adding a payment method to a merchant app;

FIGS. 3A-3C depict screen shots of exemplary user interfaces for editing a payment method linked to the user's OCC account;

FIGS. 4A-4D depict screen shots of exemplary user interfaces for adding a second payment method to a merchant app;

FIGS. 5A-5B depict screen shots of exemplary user interfaces for making a purchase using a stored payment method linked to the user's OCC account;

FIG. 6 depicts a screen shot of an exemplary web site integrated with the OCC system;

FIG. 7 depicts a block diagram illustrating exemplary aspects of the OCC system;

FIG. 8 depicts a flow diagram illustrating exemplary aspects of the OCC system;

FIG. 9 depicts a block diagram illustrating embodiments of an OCC controller.

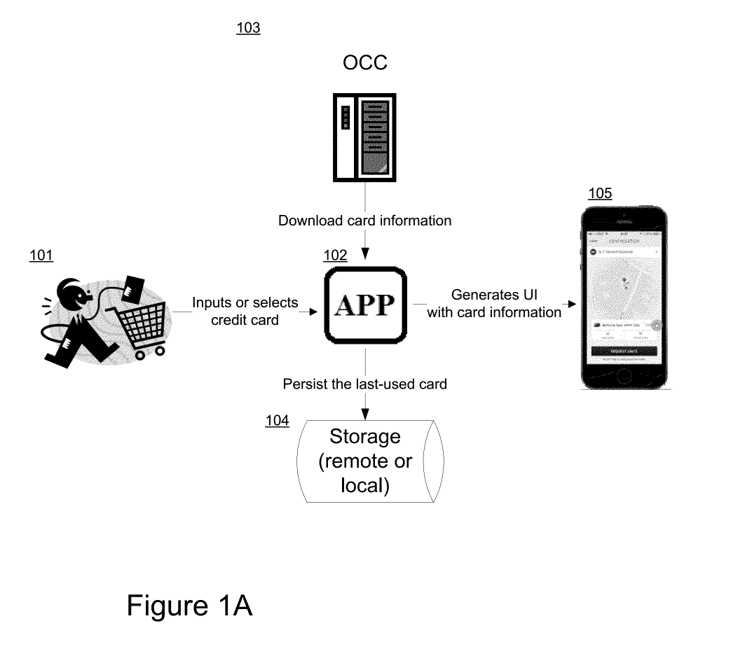

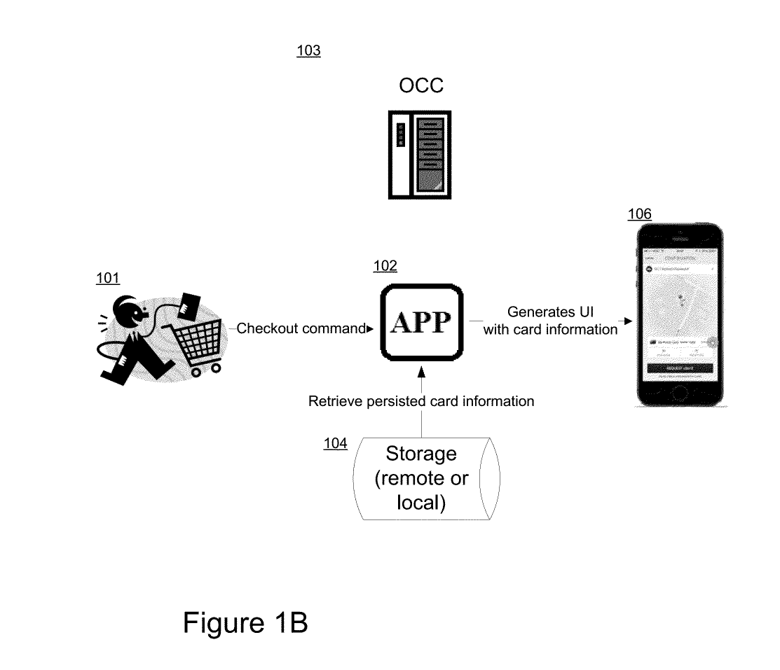

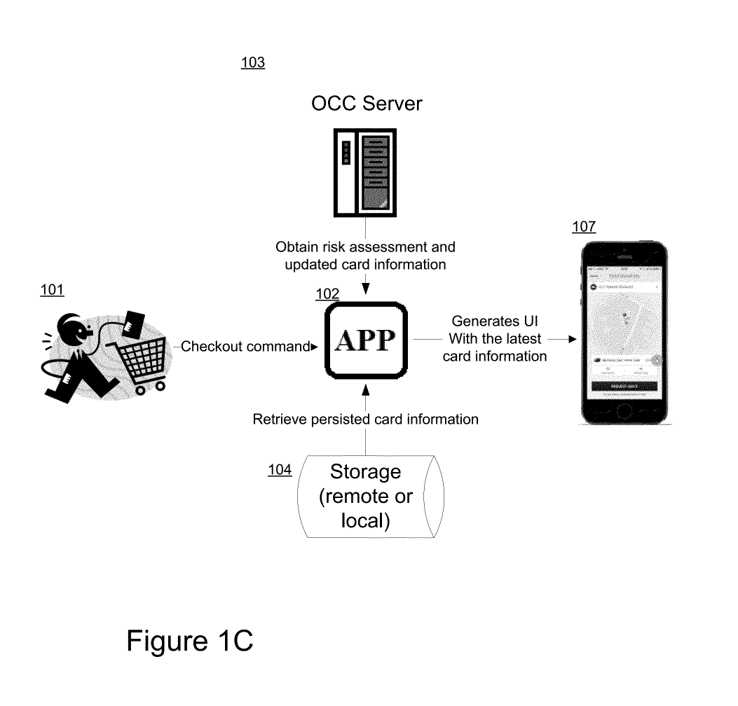

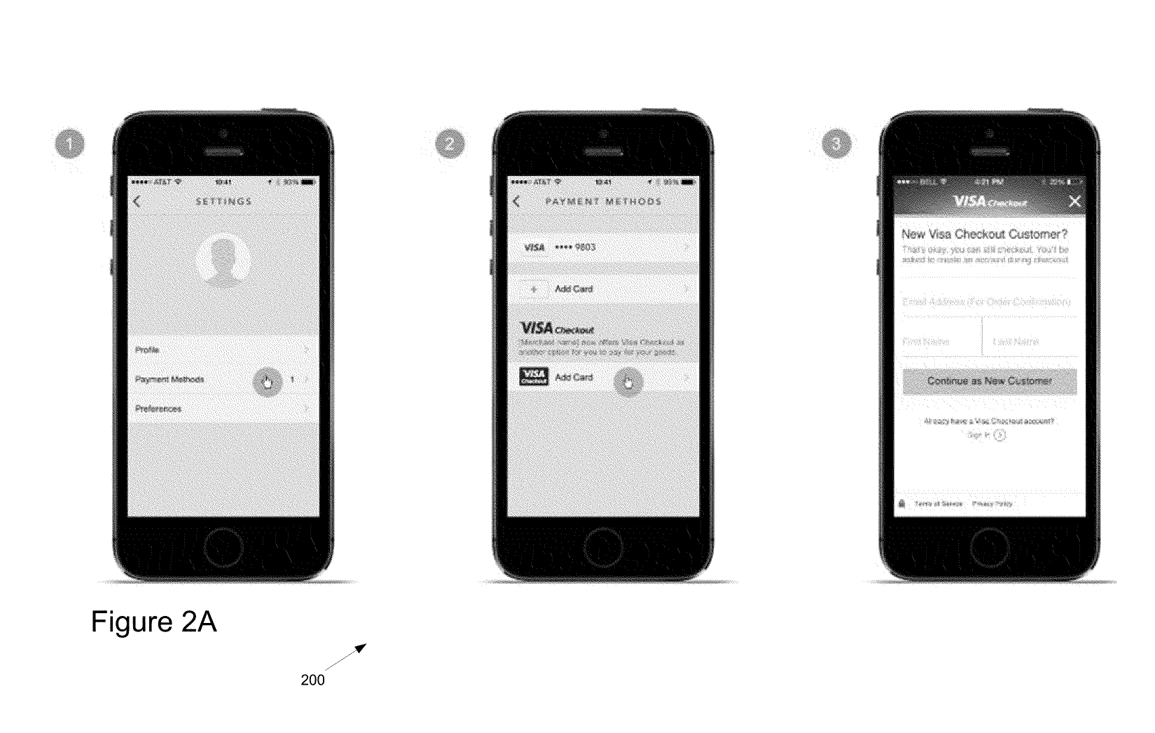

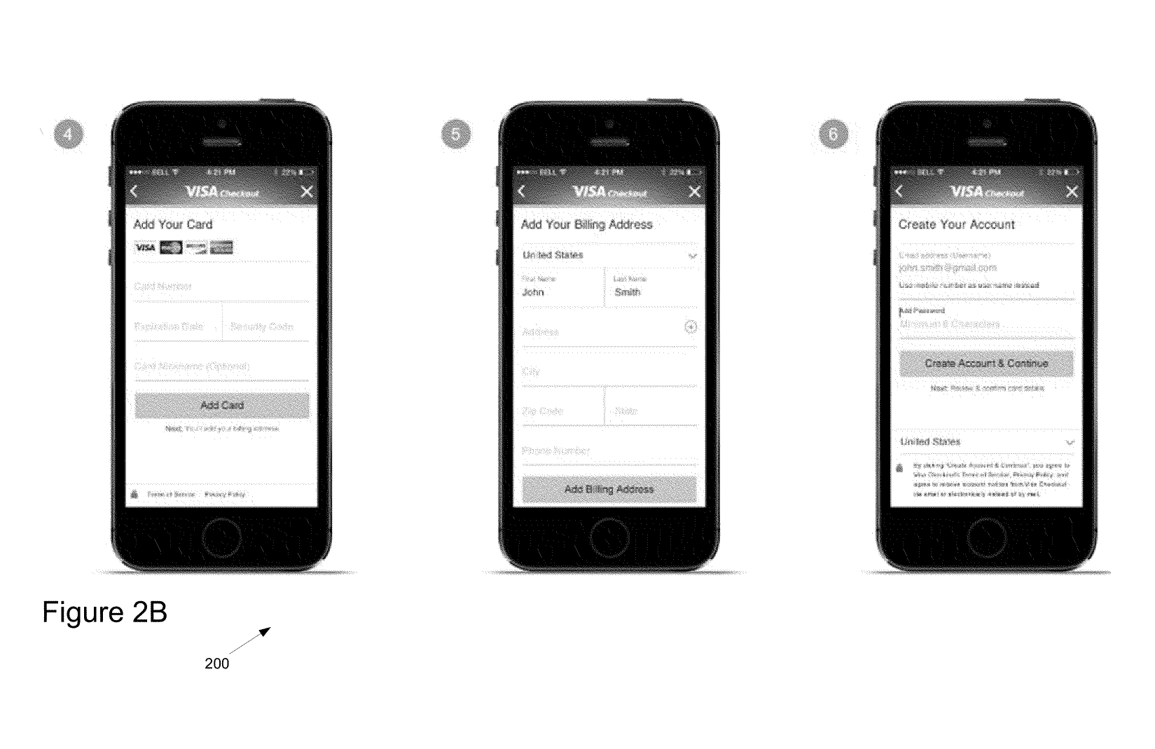

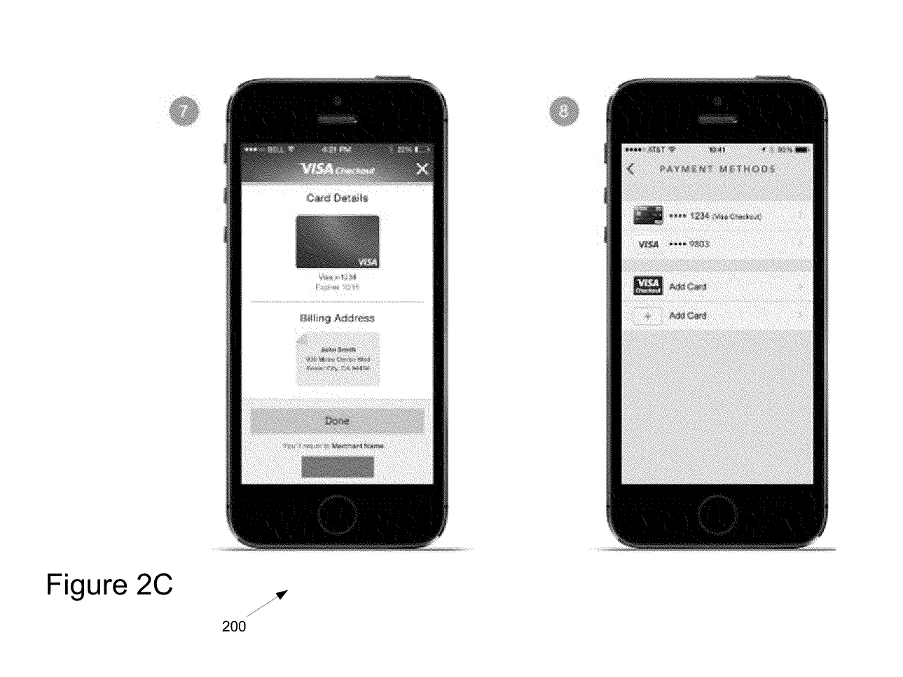

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

FIG. 1A-1C show block diagrams illustrating exemplary embodiments of the One-Click Checkout system (hereinafter referred to as “OCC”). FIG. 1A shows an embodiment where a user 101 may input his payment method information (e.g., credit card) into a mobile app 102 on his mobile device. As described in more detail below (e.g., with respect to FIGS. 2A-2C), the entered payment method may be communicated to an OCC server 103, which in turn may register the payment method with an OCC account associated with the user 101. As another example, if the payment method was already registered with the user's OCC account, the user 101 may instead log into his account and select the payment method. In either case, information associated with the payment method may be transmitted from the OCC server 103 to the merchant app 102. If the payment method is a credit card, the information transmitted may include the credit card's number, expiration date, billing address, card art, nickname, reward benefits, etc. In some implementations, the OCC server 103 may be associated with a payment service provider, such as Visa, and may have up-to-date information about the user's Visa credit card. The merchant app 102 may persist the received payment method information on a non-transitory storage medium 104, which may be located in the mobile device on which the merchant app 102 is running. Alternatively, the storage medium 104 may be located remotely, such as on a server or cloud-based service associated with the merchant app 102. The payment method information may be used by the merchant app 102 to generate a user interface 105, such as a payment screen displaying aspects of the payment method (e.g., its card art, last four digits, etc.).

Once the user's payment method information has been stored by the merchant app 102, the user 101 may make subsequent purchases with the merchant using the stored payment method information, as shown in FIGS. 1B and 1C, without needing to reenter the information. FIG. 1B shows an example where only the stored payment method information is used. The user 101 may send a checkout command to the merchant app 102. In response, the merchant app 102 may retrieve from storage 104 the payment method information last used by the user 101 and use it to generate a checkout user interface 106. Since the payment method information is only based on what was last stored, the information displayed may be obsolete.

FIG. 1C shows an alternative example where the store payment method information is updated by the OCC server 103 prior to being used each time. The user 101 may issue a checkout command to the merchant app 102, which may cause the merchant app 102 to retrieve the user's last-used payment method information from storage 104. The merchant app 102 may then query the OCC server 103 to see if the payment method information requires to be updated. For example, the merchant app 102 may request for certain credit card information, such as the expiration date, card art, billing address, etc., and compare the returned information to the corresponding stored information and make local updates if necessary. In some implementations, the merchant app 102 may transmit to the OCC server 103 an ID associated with the payment method, along with a timestamp reflecting the last time when the stored payment method was updated. The OCC server 103 may query its database for the payment method associated with that ID, and determine which of the payment method's information (e.g., expiration date, card art, etc.) has changed since the timestamp. The OCC server 103 may then transmit the changed information to the merchant app 102. The merchant app 102 may compare the received information to the corresponding stored information and determine whether to update the stored information (e.g., determine whether the locally stored information is out-of-date), or simply replace the stored version of the information with the one received from the OCC server 103. In addition, the OCC server 103 may provide risk assessment information to the merchant app 102, allowing the merchant app 102 to make an assessment as to whether to allow the payment method to be used. Based on the updated payment method information (if any) and/or risk assessment, the merchant app 102 may generate a user interface 107 with the most up-to-date information.

FIGS. 2A-2C depict screen shots at 200 of exemplary user interfaces for creating a new account with the OCC and adding a payment method to a merchant app. In the depicted example, the OCC system is branded as “VISA Checkout.” In some implementations, the OCC may provide merchants with a software development kit (SDK), which may be downloaded or otherwise obtained by the merchant software developers and integrated with the merchants' native apps, web sites, client software, etc. The SDK may be implemented using JavaScript, CSS, HTML5, Java, C++, etc.

Referring now to 200 on FIGS. 2A to 2C and starting with the screen shot on the left, labeled 1, a user may navigate to a merchant app's settings, where he may find an option to add payment methods. Selecting the payment methods setting may cause the merchant app to display screen shot 2, which shows that the user already has a stored payment method (i.e., a Visa credit card ending with 9803) but it is not linked to an OCC account. The user interface provides the user the option to add another locally stored card (i.e., one that is not linked to an OCC account) or a Visa Checkout card (i.e., a card that is linked with an OCC account). If the user selects to add a Visa Checkout card, screen shot 3 may be shown.

Screen shot 3 shows an exemplary user interface that provides users with an option to create a new Visa Checkout account or to sign in to an existing account. If the user does not have a Visa Checkout account, he may begin the account-creation process by providing personal information, such has his name and email address, and select the button, “Continue as New Customer.” On the other hand, if the user already has a Visa Checkout account, he may select the “Sign In” button, which may cause the merchant app to provide the user an opportunity to enter his credentials. In the example shown in FIGS. 2A-2C, the user elects to create a new account. Screen shot 4 then prompts the user to enter a payment method that he wishes to linked to his Visa Checkout account. The user may select a card type (e.g., Visa, MasterCard, American Express, etc.) and enter a card number, expiration date, security code, and a card nickname. In some implementations, the information solicited may depend on the merchant's configuration of the SDK. For example, if the merchant does not support using nicknames to refer to cards, that information may not be prompted for. Once he is satisfied with the entries, the user may select “Add Card.” The user interface may then advance to screen shot 5, which prompts the user to enter a billing address, which may or may not be specifically linked to the payment method just entered. In some implementations, the merchant may also prompt the user to enter a default shipping address. Next, the user interface (screen shot 6) may provide a confirmation screen and prompt the user to set a password for his account (if it has not been set already). After the user confirms the creation of the account, the information may be transmitted to a Visa Checkout server (e.g., an OCC server), which in turn may process the user information and accordingly create a user account. In some implementations, the Visa Checkout server may return a confirmation message to the merchant app, along with supplemental information (e.g., card art) related to the entered payment method. In some implementations, the supplemental information, such as card art, updated expiration dates, etc., may have been provided to Visa Checkout by credit card issuers via, e.g., a web service or API provided by Visa Checkout. In some other implementations, Visa Checkout may query card issuers for information pertaining to the cards. For example, Visa Checkout may query a card issuer to determine whether the card is credit card, debit card, gift card, prepaid card, etc. In some other implementations, the user may have selected the supplemental information, such as card art, when he added or configured the payment method. The supplemental information may also include generic or default information (e.g., a generic card art) if no specific information is available.

Having received the confirmation and/or the supplemental information, the merchant app may display a summary listing of his Visa Checkout credit cards and billing addresses, as shown in FIG. 2C, screen shot 7. In some implementations, once the user enters the Visa Checkout flow (e.g., screen shots 3 to 7), the user interface displayed may be generated based on the Visa Checkout SDK. After the user has finished creating a Visa Checkout account and adding a payment method to it, he may select “Done,” causing the user interface to return to the merchant app's payment method setting, as shown in screen shot 8. There, the user may be presented with a new Visa Checkout card entry (e.g., the card ending with 1234) as one of the available payment methods stored with the merchant app. In the exemplary implementation shown, a card that is linked with a Visa Checkout account is labeled as such with, e.g., “(Visa Checkout),” and may include a card art received from the Visa Checkout server.

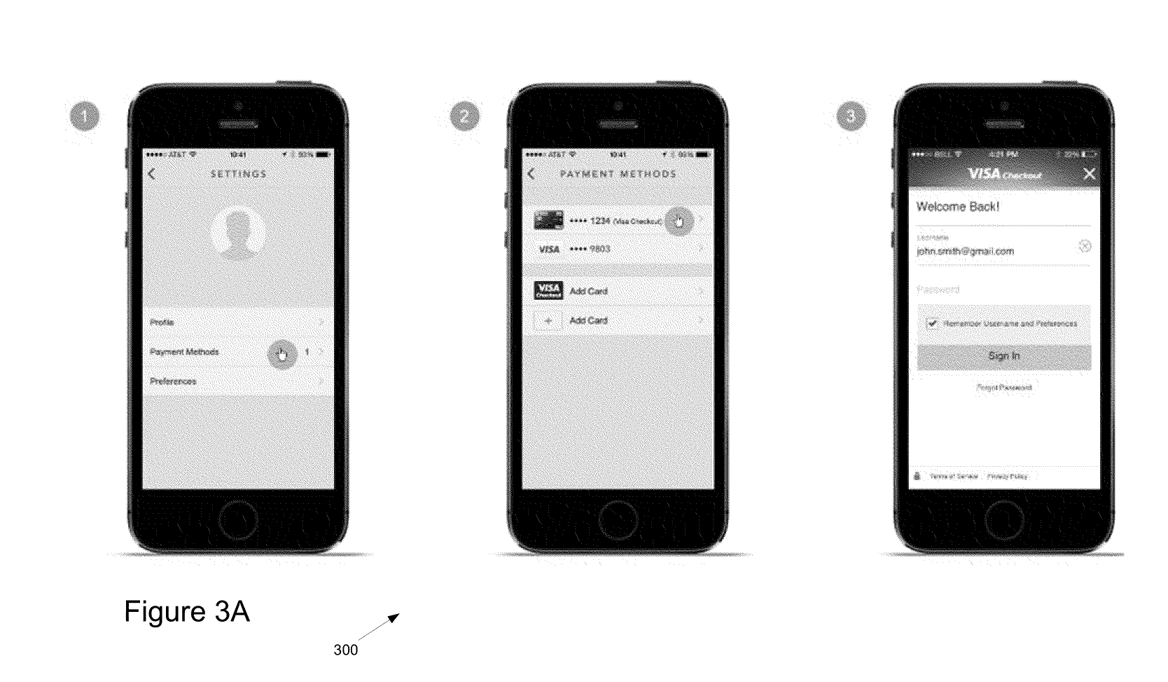

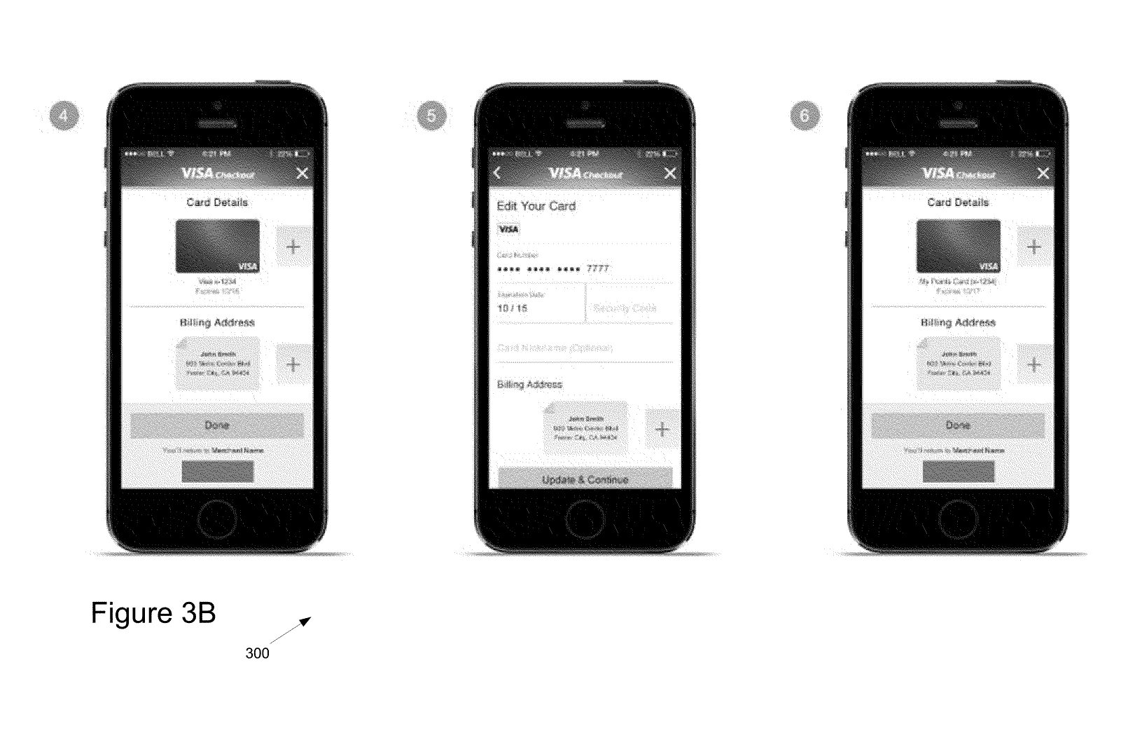

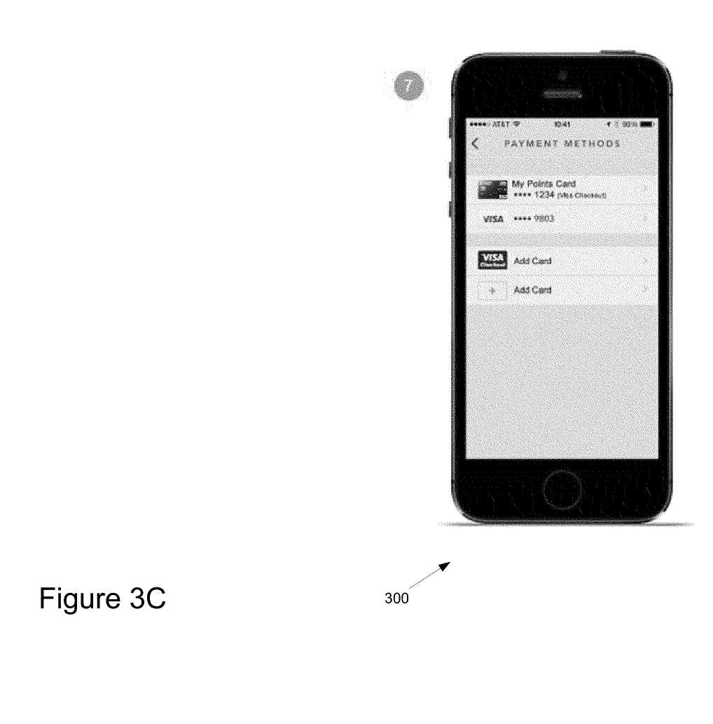

After the card has been added to the user's Visa Checkout account (as shown above by FIGS. 2A-2C), the user may edit it, which is the exemplary scenario shown at 300 in FIGS. 3A-3C. For example, the user may begin by navigating to the merchant app's payment method settings (FIG. 3A, screen shot 1). The user may then select a payment method that he wants to edit, which in the example shown in screen shot 2 is the card ending with 1234 and linked to a Visa Checkout account. In some implementations, the merchant app may then generate a sign-in screen (e.g., screen shot 3) based on the Visa Checkout SDK. In some implementations, if the user chose to have the merchant app remember his username and password, screen shot 3 may be skipped. The user credentials may be transmitted to the Visa Checkout server, and upon successful authentication the Visa Checkout server may return the payment methods and billing addresses linked to the user's account. The account information received may be displayed as shown in FIG. 3B, screen shot 4. The user may select any of the displayed information and edit it. For example, the user may select one of his payment methods, causing the user interface to display a form for editing the selected payment method's information (e.g., screen shot 5). Once satisfied with the edits, the user may select “Update & Continue,” which may cause the merchant app to transmit an edit request to the Visa Checkout server with the newly entered information. The Visa Checkout server may update the user's payment method accordingly, and respond with a confirmation message. The merchant app may then display a summary (e.g., screen shot 6) of the payment methods and billing addresses linked to the user's Visa Checkout account, including any updated information. Once the user confirms that he is done editing, the user interface may return to the app's payment method settings (e.g., FIG. 3C, screen shot 7).

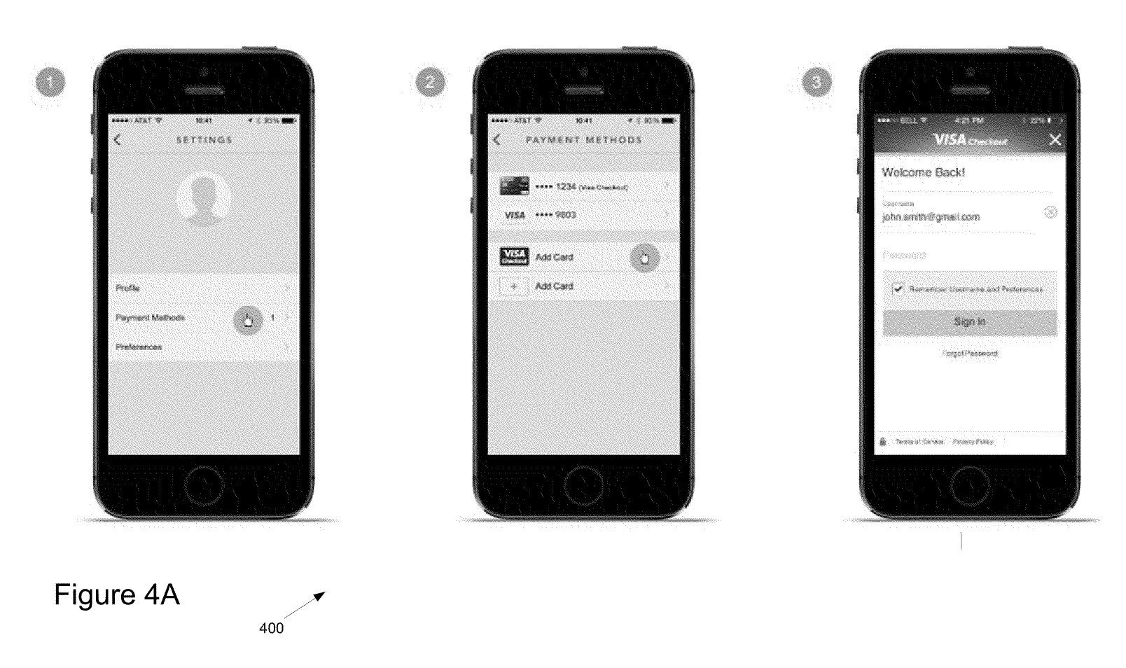

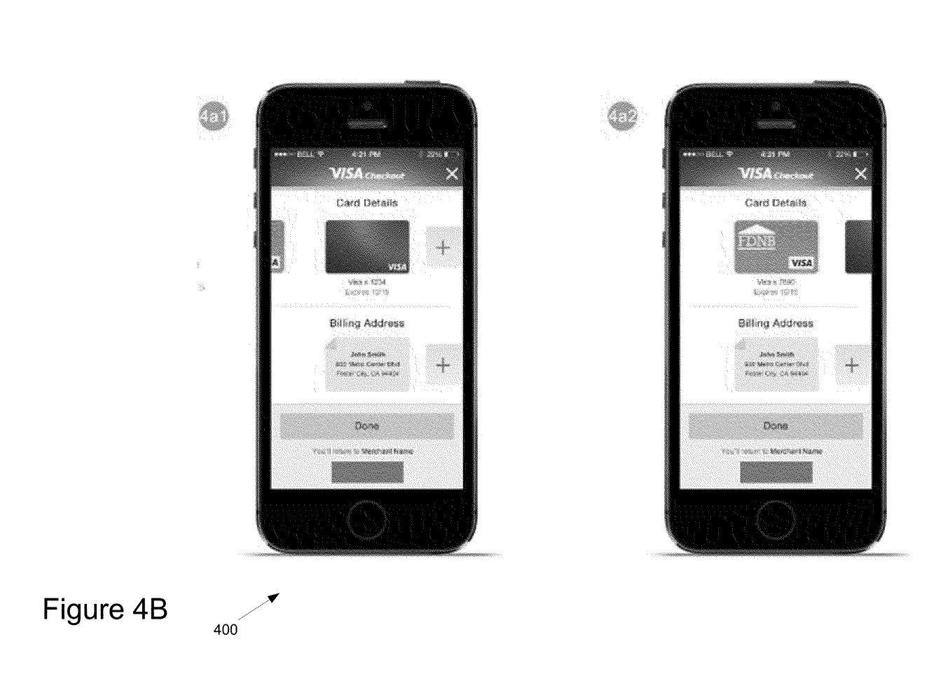

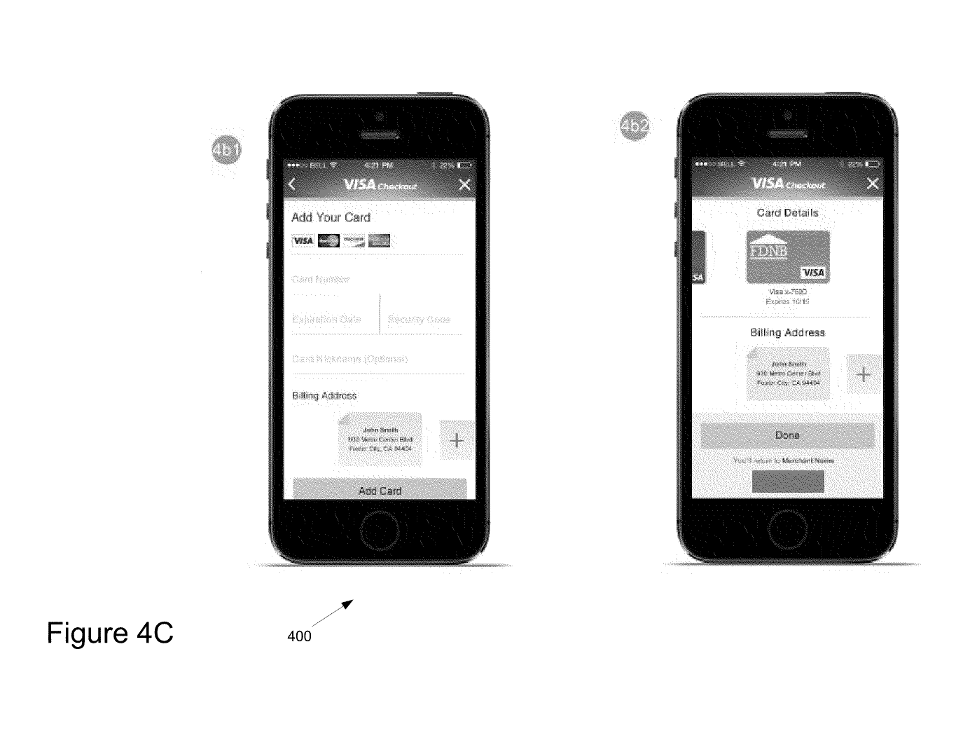

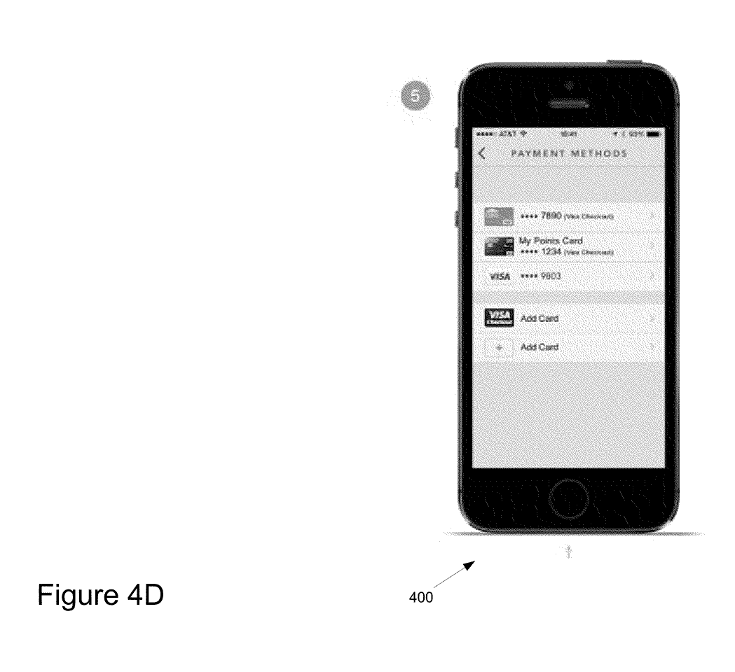

FIGS. 4A-4D depict screen shots at 400 of exemplary user interfaces for adding a second payment method. FIG. 4A, screen shot 1 shows a user selecting an exemplary merchant app's settings for payment methods. Screen shot 2 shows an exemplary user interface of the payment method settings, which may display a listing of prestored payment methods (e.g., the cards shown ending with 1234, which is linked to a Visa Checkout account, and the card ending with 9803). The user may choose to add another Visa Checkout card, which may cause the merchant app to invoke a user interface based on the Visa Checkout SDK, as shown by screen shot 3. In some implementations, the user may be prompted to enter his credentials for Visa Checkout. In other implementations, the user's credentials may be persisted on the user's device, and therefore the prompt for user credentials may be omitted.

FIG. 4B shows screen shots of an exemplary scenario where the user may have multiple cards linked to his Visa Checkout account. In screen shot 4a1, the user may be shown one of his cards, namely a card that ends with 1234. In some implementations, the user may swipe towards the right to have his other card displayed, namely a Visa card ending with 7890, as shown in FIG. 4a2. The user may select a card by, e.g., tapping on its card art, to have the card be added to the user's merchant app account.

FIG. 4C shows screen shots of an exemplary scenario where all of the user's Visa Checkout cards have already been added to the merchant app, and therefore the user interface (e.g., screen shot 4b1) prompts the user to add a new card. After the user enters all the necessary information and adds the card, the information may be transmitted to a Visa Checkout server, which in turn may add the card to the user's account. If the process succeeds, the Visa Checkout server may transmit a confirmation message to the user's device, along with supplemental information about the user's card, such as a card art. Once the confirmation and/or supplemental information is received, the user's device may display a confirmation message, such as the one shown in screen shot 4b2. In some implementations, the user may then select the newly added card (or another card) to indicate that the card is to be added to his merchant account. In other implementations, the newly added card will by default be added to the user's merchant app account. FIG. 4D shows a screen shot where a second Visa Checkout card is added to the merchant's stored payment methods (namely, the card ending with 7890).

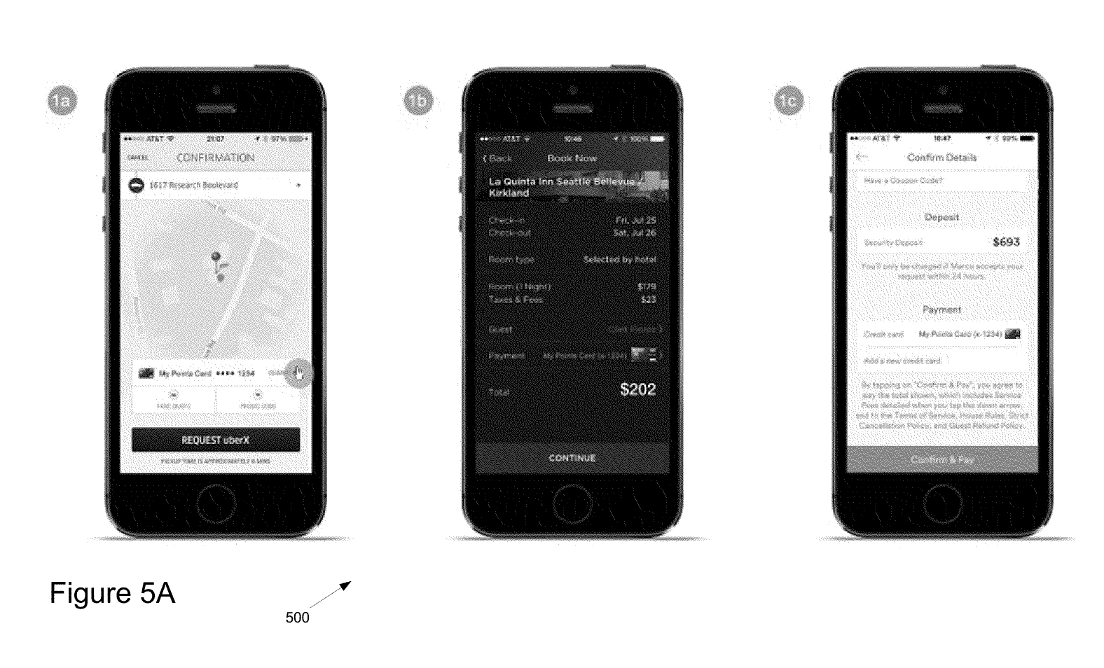

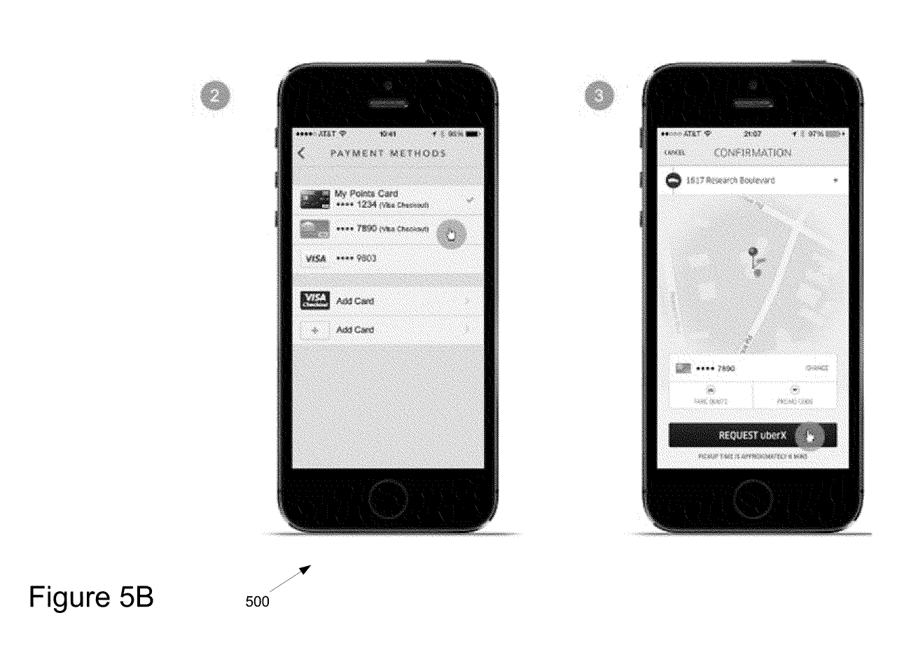

FIG. 5A-5B depict screen shots at 500 of exemplary user interfaces for making a purchase using a stored payment method. Screen shot is depicts an exemplary merchant app, such as Uber, displaying a payment method stored by the merchant app. In some implementations, the payment method displayed may be the default payment method set by the user. In some other implementations, the payment method displayed may be the payment method that the user last used to make a purchase. Screen shot 1b displays another exemplary merchant app, such as Hotel Tonight, displaying the user's stored payment method at the checkout screen. Screen shot is provides yet another exemplary merchant app, such as AirBnB, that displays the user's stored payment method during checkout. If the user wishes to use a different payment method (e.g., by selecting “CHANGE,” a graphical interface such as a “>” symbol, by tapping and holding, and/or the like), the merchant app may display a listing of the user's payment methods stored with the merchant, such as the display shown in FIG. 5B, screen shot 2. The user may select one of the payment methods, and the merchant app may reflect the selection in its checkout user interface as shown in screen shot 3.

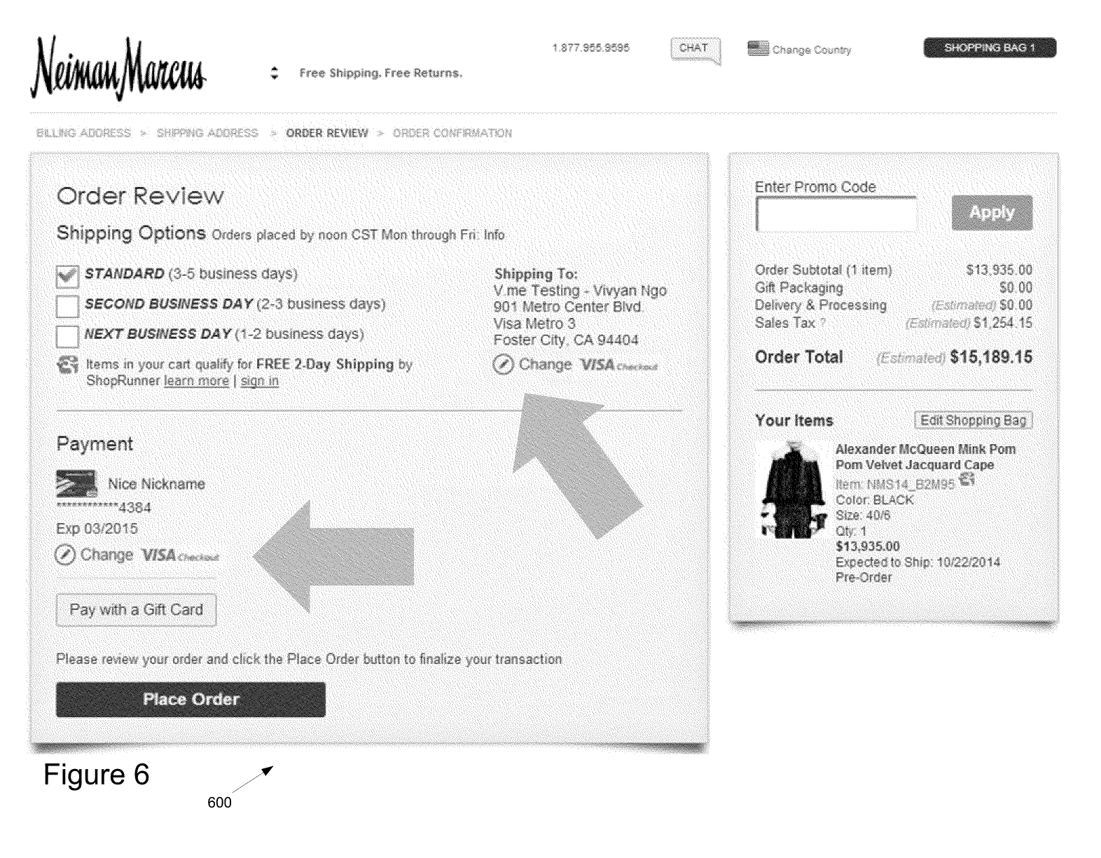

FIG. 6 depicts at 600 a screen shot of an exemplary web site integrated with the OCC system. In some implementations, the merchant web site may keep track of the payment method used by the user and automatically present the last-used (or default) payment method on the checkout screen. In some implementations, the last-used payment method may be the most recently used payment method across the merchant's sales channels, such as its web site, mobile app, phone, etc. In some implementations, when the merchant web server generates the checkout page, the web server may query the OCC server to obtain the most up-to-date information for the user's last-used payment method, such as card art, nick name, expiration date, etc. The information received from the OCC may be used to update the merchant's copy of the payment method information and to generate the checkout screen. In the example shown in FIG. 6, the user's payment method ending with 4384, along with an associated card art and nickname, may be displayed. If the user wishes to use a different payment method or to update the displayed payment method, he may select the “Change Visa Checkout” button. In response, the merchant's web server may, for example, invoke a Visa Checkout SDK to generate the user interface for editing and/or selecting a payment method linked to the user's Visa Checkout account, similar to the mobile app implementation described above (e.g., FIGS. 3A-3C, 4A-4D).

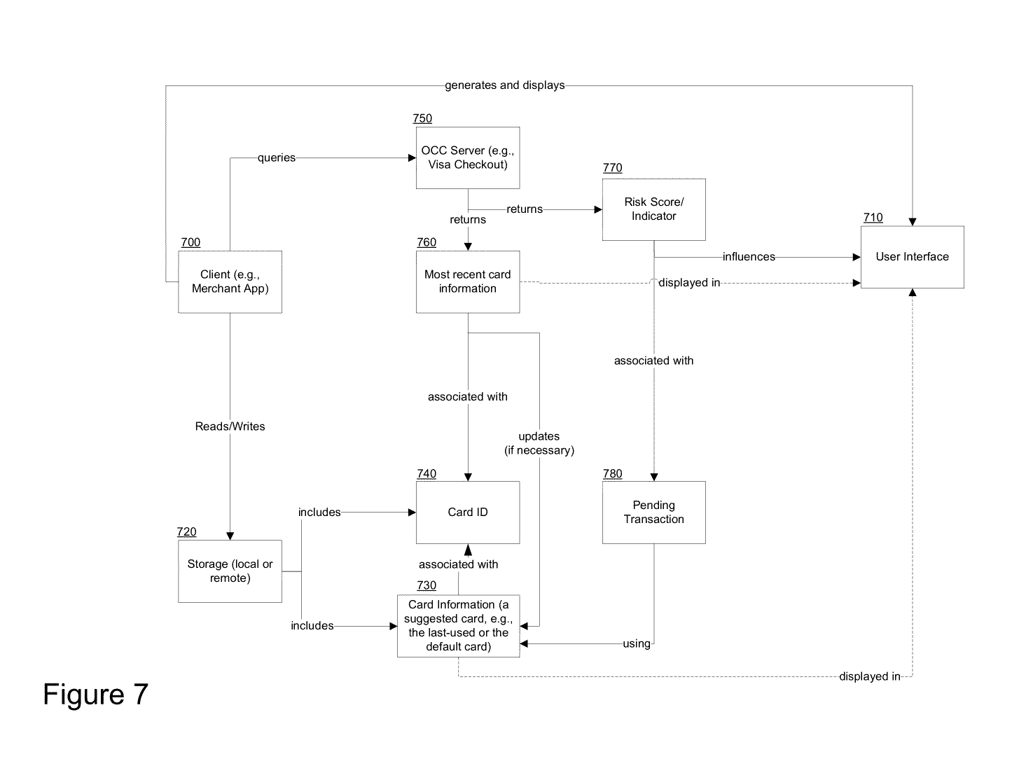

FIG. 7 depicts a block diagram illustrating exemplary aspects of the OCC system. In some embodiments, a user may be interested in engaging in a payment transaction with a merchant via a client 700 operating under the instructions associated with the merchant (e.g., a mobile device operating in accordance with a merchant's app, a computer operating in accordance with the merchant's web site/web pages, and/or the like). The instructions may cause the client 700 to generate and display a checkout user interface 710. In some implementations, the client 700 may identify and/or authenticate the user by prompting the user for his account credentials with the merchant. In some other implementations, the client 700 (e.g., a merchant mobile app) may assume the user is authenticated (since the user has access to the mobile device).

The client 700 may access storage media 720 to determine if the identified/authenticated user has any registered payment methods. The storage media 720 may be located locally with the client (e.g., the storage media of the mobile device running the merchant app or the storage media of the web server hosting the merchant web site), or located remotely (e.g., made accessible via a merchant server or cloud). In some implementations, the client 700 may automatically determine a suggested payment method to be displayed to the user, and retrieve the associated payment method information 730 (e.g., full or partial credit card number, expiration date, billing address, nickname, card art, etc.). The suggested payment method may be determined based on the user's last-used or default payment method information. For example, the client 700 may identify the last-used or default payment method in any conventional way known to one of ordinary skill in the art (e.g., the user's account may include a field specifying the last-used or default payment method, or each of the user's registered payment methods may include a flag indicating whether it is the default or last-used payment method). In some other implementations, the suggested payment method may be determined using machine learning or by some other logic-based decision. For example, the suggested payment method may be the most frequently used payment method in the last ten transactions. As another example, the suggested payment method may be based on the user's card-use pattern, such as using a particular card for buying electronics, another card for buying medicine, etc. (e.g., because some cards may offer bonus rewards or incentives for buying particular types of goods). In yet another example, the suggested payment method may be determined based on a determination of which of the user's payment method may offer the most benefit (e.g., reward points, cash back, etc.) given the product that the user is interested in buying. In addition, a suggested billing and/or shipping address may also be determined. For example, the last-used or default billing and/or shipping address may be selected. In another example, the billing and/or shipping address that the user historically uses with the particular selected payment method may be selected (e.g., if card X is the last-used card, the billing address may also be the one that was last used, but the shipping address may be selected based on the address that was most frequently used in the last, e.g., three months).

If the payment method is linked to the user's OCC account, the client 700 may also retrieve an identification number 740 associated with the payment method 730, which can be used to query for information from an OCC server 750. In some other implementations where the client 700 is designed to only use dynamically retrieved payment method information from the OCC server 750, the client 700 may only retrieve (and may only store) the identification number 740 and not the associated payment method information. In some implementations, the identification number 740 may be assigned by the OCC server and may uniquely reference the particular payment method and may be unique to the particular merchant. For example, the identification number assigned to merchant ABC may be different from the identification number assigned to merchant XYZ, even though the two identification numbers refer to the same credit card number. This provides an added layer of privacy and security for users.

If the payment method is linked to an OCC account (e.g., a Visa Checkout account), the client 700 may, in some implementations prompt the user for his OCC account credential and use it to connect with the OCC server 750 in order to query for additional/updated information associated with the user's payment method. In some implementations, the client 700 may transmit the user's OCC credential and the identification 740 (which may be an assigned ID, the full or partial credit card number, the user's address, etc.) associated with payment method to the OCC server 750. The OCC server 750 may authenticate the received OCC credential and return OCC information or payment-service-provider information 760 (i.e., information from the OCC or payment-service-provider) associated with the payment method (e.g., based on the identification number 740) to the client 700. The returned information 760 may reflect the most recent changes to the payment method made by, e.g., the user (e.g., a change in billing address or nickname, card art, etc.) or by a payment provider (e.g., a renewed expiration date, card art, etc.). The client 700 may update the merchant copy of the payment method information 730 with the information 760 received from the OCC server 750. The client 700 may use any combination of the received information 760 and the stored information 730 to generate the user interface 710. For example, the client 700 may check/confirm whether the received information 760 is different from the stored information 730. If differences are detected, the client 700 may update the stored information 730 accordingly and use the updated version of information 730 to generate the user interface 710. As another example, the client 700 may only use the information received 760 (since it is presumed to be the most up-to-date). As yet another example, the client 700 may query for recently changed information (e.g., information that has changed since the last time the merchant queried for the information) and use the query results 760 along with portions of the stored information 730 to generate the user interface 710. By using the dynamic information 760 obtained from the OCC server 750, the client 700 is able to confirm that the user's payment information is up-to-date, thereby increasing the likelihood that the payment method, when submitted for payment, would successfully pass authentication. In addition, by showing the user the card art, nickname, and other information associated with his card at checkout gives the user confidence and a sense of security.

The OCC server may also return a risk score or indicator 770 associated with the pending transaction 780 that the user may pay with the payment method 730. In some implementations, the client 700 may transmit to the OCC server information about the pending transaction 780, such as the merchant identification, the transaction amount, the transaction location, the payment method (as identified by a reference ID 740 or card information 730) that the user may use, etc. The OCC server may, in some implementations, validate that the merchant has permission to make the inquiry, and perform a silent speculative “checkout” (i.e., one that isn't committed) based on the information provided to determine a risk score/indicator 770. The risk score/indicator 770, for example, may be a numerical value between 1 and 100, a categorical indicator (e.g., whether the transaction is authorized or denied), a transaction guarantee by the card's issuer, and/or the like. The risk score/indicator 770 may be transmitted to the client 700, which in turn may use the risk score/indicator 770 to determine whether the payment method 730 may be used or if the user needs to be prompted to select or enter a different payment method. The risk score/indicator 770 may, e.g., help mitigate the risk of the transaction resulting in a chargeback.

Upon seeing the user interface 710 and the default payment method, the user may either proceed with checking out with that payment method or change it (or aspects of it). The user interface may be generated based on a management tool provided by the OCC system, and may take the form of an SDK, API, and/or the like. When the user is satisfied with the payment method, he may proceed with the checkout. At that time, the client 700 may transmit the payment information (e.g., credit card number, the user's name, billing address, expiration date, etc.) to the payment method's processor to authenticate and approve the payment. In some implementations, the client 700 may transmit the payment information either directly to the payment method processor or indirectly via an associated merchant server, without involving the OCC server in the final payment authorization process once the user has confirmed to buy. In some other implementations, the client may call upon the OCC server to process the payment.

In some implementations, a user's payment method, which may include a billing address and other associated information, may be persisted and updated as a unit. In some other implementations the unit of information may be more granular. For example, the merchant may store credit card information and billing addresses without necessarily linking them to each other. Thus, the merchant may keep track of the user's last-used/default credit card information as well as a separate last-used/default billing address. If the user wishes to change either the credit card used or billing address used, he may select either one and make changes without affecting the other (e.g., the user may choose to use a different credit card, but continue to use the last-used/default billing address).

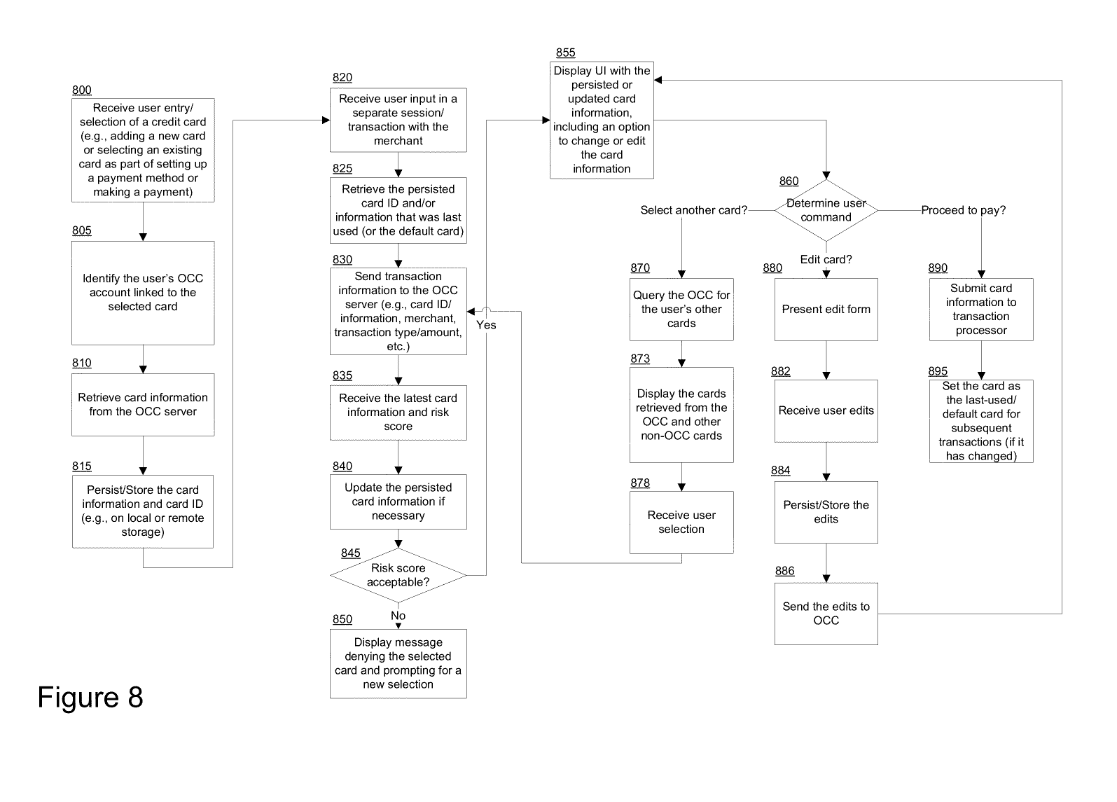

FIG. 8 depicts a flow diagram illustrating exemplary aspects of the OCC system. Steps Boo, 805, 810, and 815 depict exemplary aspects of the initial process for adding an OCC-linked credit card (or any other type of payment method, such as PayPal, banking account, etc.) to a merchant system. In some implementations, a merchant's virtual store front (e.g., a merchant app or web site) may allow a user to add a new credit card, edit a stored card, select a stored cards to make a payment, and/or the like. For example, the user may tap a visual representation of the credit card displayed in a merchant mobile app, or click on a visual representation of a credit card displayed in a merchant web site and cause the web site to forward the user selection, via HTTP and/or the like, to the web server hosting the web site. When the merchant receives the user entry or selection Boo of a credit card, the merchant system may determine if the credit card is linked with the user's OCC account 805. For example, if the user is entering a new credit card, the merchant system may prompt the user to link the card with a new or existing OCC account. If the user is editing or selecting a stored card, the merchant system may access previously stored data indicating whether the card is linked with an OCC account. If the credit card is or is being linked with an OCC account, the merchant system may request an OCC server for information associated with the credit card 810, such as its card art, nickname, expiration date, etc. The received information may be persisted/stored 815 by the merchant system so that the merchant system retains a copy of the card's last information.

The user may use the stored credit card in subsequent transactions with the merchant. In some implementations, the merchant system may receive a user input indicating that he wishes to transact with the merchant 820 (e.g., by clicking on a “checkout” button, by browsing the merchant's catalog or his wish list, etc.). In response, the merchant system may identify the credit card that was last used or saved by the user or that was set as the default payment method 825. In some implementations, the merchant system may transmit an identification number associated with the card to the OCC server 830 and query for information associated with the card (e.g., the card's expiration date, card art, etc.) The merchant system may receive the information and/or a risk score (or equivalent indicators of risk and/or card authorization) from the OCC server 835. The merchant system may update its copy of the credit card information based on the information received 840. If the merchant received a risk score, it may determine whether or not the risk score (or equivalent) is acceptable 845. If it is not, the merchant may display a message denying the card and prompt the user to select or enter another payment method 850. On the other hand, if the risk score is acceptable, the merchant may proceed to generate and display a user interface that includes the last-used or default credit card 855. The credit card information used to generate the user interface may be drawn from the information received from the OCC server and/or the prestored information. In some implementations, the user interface may also include options for the user to select another payment method or to edit the displayed credit card's information.

The user may respond to the displayed user interface by inputting a command. If the user entered a payment method selection command 860, the merchant system may query the OCC server 870 for information associated with any of the user's other cards stored with the merchant system (in other implementations, this step of querying the OCC server may be performed after the user has selected a specific card). The merchant system may then display the user's other payment method options 873, including both the ones linked with the user's OCC account and the ones that are not. After receiving a selection from the user 878, the merchant system may send transaction information to the OCC server to obtain information associated with the selected payment method (if the information has not already been queried for, such as at step 870) and/or a risk score. The merchant system may then generate another user interface to reflect the new selection, as described above.

If at 860 the user instead selects to edit the credit card shown, the merchant system may display an edit form 880 (e.g., including text boxes, check boxes, radio buttons, sliding tools, etc.). Once the merchant system receives the user edits 882, it may persist/store the edits locally or on a remote server 884. In some implementations, the merchant system may also send (e.g., via the merchant SDK) the edit information to the OCC server 886, allowing it to also update its copy of the credit card information. Once the edit has been completed, the merchant system may again generate and display a user interface with the updated information 855.

If at 860 the user instead indicates that he wishes to complete the order with the credit card displayed/selected, the merchant system may submit the credit card information to a transaction processor to process the payment request 890. In addition, the merchant system may store an indication that the credit card was the last-used card 895, so that it would again be displayed to the user automatically when the checkout user interface (e.g., 855) is again generated.

### OCC Controller

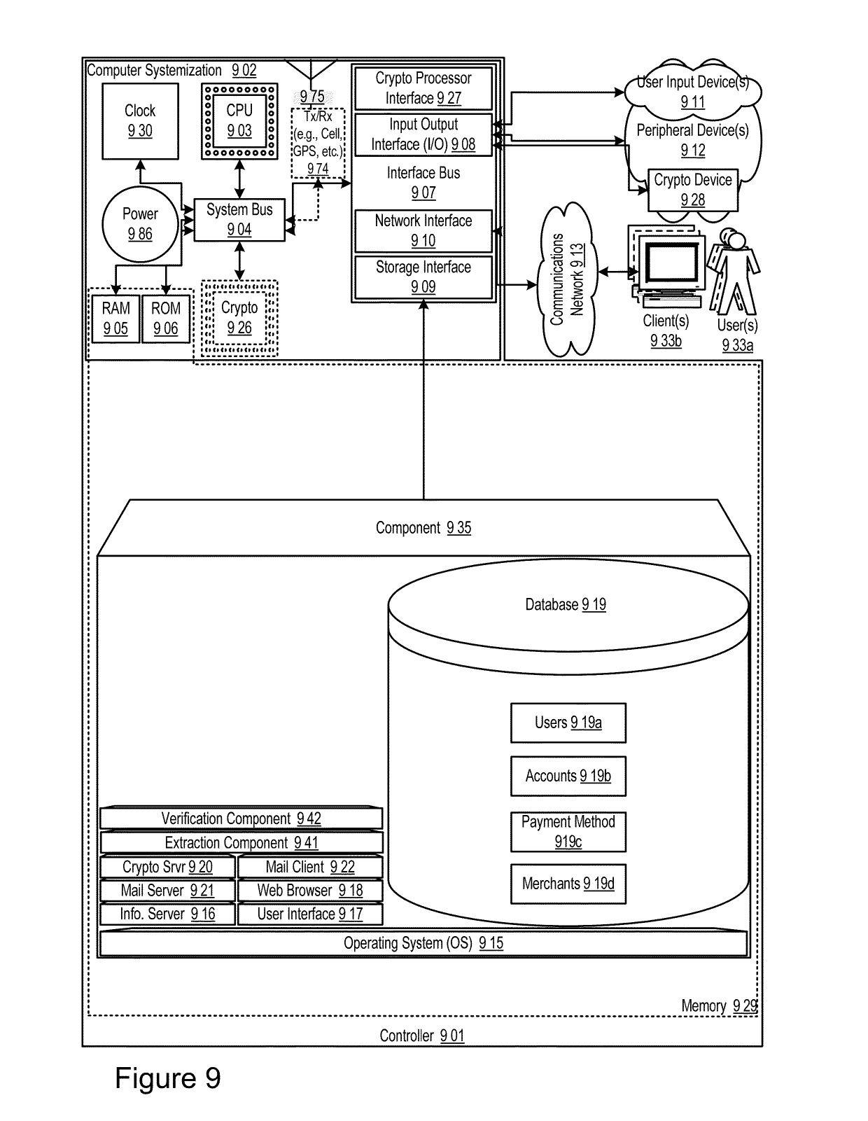

FIG. 9 shows a block diagram illustrating embodiments of an OCC controller. In this embodiment, the OCC controller 901 may serve to aggregate, process, store, search, serve, identify, instruct, generate, match, and/or facilitate interactions with a user.

Typically, users, which may be people and/or other systems, may engage information technology systems (e.g., computers) to facilitate information processing. In turn, computers employ processors to process information; such processors 903 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 929 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the OCC controller 901 may be connected to and/or communicate with entities such as, but not limited to: one or more users from user input devices 911; peripheral devices 912; an optional cryptographic processor device 928; and/or a communications network 913.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The OCC controller 901 may be based on computer systems that may comprise, but are not limited to, components such as: a computer systemization 902 connected to memory 929.

### Computer Systemization

A computer systemization 902 may comprise a clock 930, central processing unit (“CPU(s)” and/or “processor(s)” (these terms are used interchangeable throughout the disclosure unless noted to the contrary)) 903, a memory 929 (e.g., a read only memory (ROM) 906, a random access memory (RAM) 905, etc.), and/or an interface bus 907, and most frequently, although not necessarily, are all interconnected and/or communicating through a system bus 904 on one or more (mother)board(s) 902 having conductive and/or otherwise transportive circuit pathways through which instructions (e.g., binary encoded signals) may travel to effectuate communications, operations, storage, etc. The computer systemization may be connected to a power source 986; e.g., optionally the power source may be internal. Optionally, a cryptographic processor 926 and/or transceivers (e.g., ICs) 974 may be connected to the system bus. In another embodiment, the cryptographic processor and/or transceivers may be connected as either internal and/or external peripheral devices 912 via the interface bus I/O. In turn, the transceivers may be connected to antenna(s) 975, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing OCC controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 929 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the OCC controller and beyond through various interfaces. Should processing requirements dictate a greater amount speed and/or capacity, distributed processors (e.g., Distributed OCC), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the OCC may be achieved by implementing a microcontroller such as CAST's R8051XC2 microcontroller; Intel's MCS 51 (i.e., 8051 microcontroller); and/or the like. Also, to implement certain features of the OCC, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the OCC component collection (distributed or otherwise) and/or features may be implemented via the microprocessor and/or via embedded components; e.g., via ASIC, coprocessor, DSP, FPGA, and/or the like. Alternately, some implementations of the OCC may be implemented with embedded components that are configured and used to achieve a variety of features or signal processing.

Depending on the particular implementation, the embedded components may include software solutions, hardware solutions, and/or some combination of both hardware/software solutions. For example, OCC features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the OCC features. A hierarchy of programmable interconnects allow logic blocks to be interconnected as needed by the OCC system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the OCC may be developed on regular FPGAs and then migrated into a fixed version that more resembles ASIC implementations. Alternate or coordinating implementations may migrate OCC controller features to a final ASIC instead of or in addition to FPGAs. Depending on the implementation all of the aforementioned embedded components and microprocessors may be considered the “CPU” and/or “processor” for the OCC.

### Power Source

The power source 986 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 986 is connected to at least one of the interconnected subsequent components of the OCC thereby providing an electric current to all subsequent components. In one example, the power source 986 is connected to the system bus component 904. In an alternative embodiment, an outside power source 986 is provided through a connection across the I/O 908 interface. For example, a USB and/or IEEE 1394 connection carries both data and power across the connection and is therefore a suitable source of power.

### Interface Adapters

Interface bus(ses) 907 may accept, connect, and/or communicate to a number of interface adapters, conventionally although not necessarily in the form of adapter cards, such as but not limited to: input output interfaces (I/O) 908, storage interfaces 909, network interfaces 910, and/or the like. Optionally, cryptographic processor interfaces 927 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 909 may accept, communicate, and/or connect to a number of storage devices such as, but not limited to: storage devices 914, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 910 may accept, communicate, and/or connect to a communications network 913. Through a communications network 913, the OCC controller is accessible through remote clients 933b (e.g., computers with web browsers) by users 933a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed OCC), architectures may similarly be employed to pool, load balance, and/or otherwise increase the communicative bandwidth required by the OCC controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 910 may be used to engage with various communications network types 913. For example, multiple network interfaces may be employed to allow for the communication over broadcast, multicast, and/or unicast networks.

Input Output interfaces (I/O) 908 may accept, communicate, and/or connect to user input devices 911, peripheral devices 912, cryptographic processor devices 928, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 911 often are a type of peripheral device 912 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 912 may be connected and/or communicate to I/O and/or other facilities of the like such as network interfaces, storage interfaces, directly to the interface bus, system bus, the CPU, and/or the like. Peripheral devices may be external, internal and/or part of the OCC controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 928), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the OCC controller may be embodied as an embedded, dedicated, and/or monitor-less (i.e., headless) device, wherein access would be provided over a network interface connection.

Cryptographic units such as, but not limited to, microcontrollers, processors 926, interfaces 927, and/or devices 928 may be attached, and/or communicate with the OCC controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 929. However, memory is a fungible technology and resource, thus, any number of memory embodiments may be employed in lieu of or in concert with one another. It is to be understood that the OCC controller and/or a computer systemization may employ various forms of memory 929. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 929 will include ROM 906, RAM 905, and a storage device 914. A storage device 914 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 929 may contain a collection of program and/or database components and/or data such as, but not limited to: operating system component(s) 915 (operating system); information server component(s) 916 (information server); user interface component(s) 917 (user interface); Web browser component(s) 918 (Web browser); database(s) 919; mail server component(s) 921; mail client component(s) 922; cryptographic server component(s) 920 (cryptographic server); the OCC component(s) 935, including components 641-642; and/or the like (i.e., collectively a component collection). These components may be stored and accessed from the storage devices and/or from storage devices accessible through an interface bus. Although non-conventional program components such as those in the component collection, typically, are stored in a local storage device 914, they may also be loaded and/or stored in memory such as: peripheral devices, RAM, remote storage facilities through a communications network, ROM, various forms of memory, and/or the like.

### Operating System

The operating system component 915 is an executable program component facilitating the operation of the OCC controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the OCC controller to communicate with other entities through a communications network 913. Various communication protocols may be used by the OCC controller as a subcarrier transport mechanism for interaction, such as, but not limited to: multicast, TCP/IP, UDP, unicast, and/or the like.

### Information Server

An information server component 916 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the OCC controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the OCC database 919, operating systems, other program components, user interfaces, Web browsers, and/or the like.

Access to the OCC database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the OCC. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the OCC as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 917 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 918 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the OCC enabled nodes. The combined application may be nugatory on systems employing standard Web browsers.

### Mail Server

A mail server component 921 is a stored program component that is executed by a CPU 903. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the OCC.

Access to the OCC mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 922 is a stored program component that is executed by a CPU 903. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 920 is a stored program component that is executed by a CPU 903, cryptographic processor 926, cryptographic processor interface 927, cryptographic processor device 928, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the OCC may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the OCC component to engage in secure transactions if so desired. The cryptographic component facilitates the secure accessing of resources on the OCC and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The OCC Database

The OCC database component 919 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the OCC database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the OCC database is implemented as a data-structure, the use of the OCC database 919 may be integrated into another component such as the OCC component 935. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 919 includes several tables 919a-d. A users table 919a includes fields such as, but not limited to: user_ID, user_name, user_address, user_email, user_DOB, and/or the like. The user account table may support and/or track multiple users on a OCC. An accounts table 919b includes fields such as, but not limited to: account_ID, account_password, account_user_ID, account_payment_method_ID, account_preferences, account_shipping_address, and/or the like. The accounts table may support and/or track multiple accounts on an OCC. A payment method table 919c includes fields such as, but not limited to: pm_ID, pm_type, pm_number, pm_billing_address, pm_expiration_date, pm_card_art, pm_nickname, and/or the like. A merchant table 919d includes fields such as, but not limited to: merchant_ID, merchant_address, merchant_name, merchant_email, merchant_account status, and/or the like. The merchant table may support and/or track multiple merchant accounts on an OCC.

In one embodiment, the OCC database may interact with other database systems. For example, employing a distributed database system, queries and data access by search OCC component may treat the combination of the OCC database, an integrated data security layer database as a single database entity.

In one embodiment, user programs may contain various user interface primitives, which may serve to update the OCC. Also, various accounts may require custom database tables depending upon the environments and the types of clients the OCC may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 919a-d. The OCC may be configured to keep track of various settings, inputs, and parameters via database controllers.

The OCC database may communicate to and/or with other components in a component collection, including itself, and/or facilities of the like. Most frequently, the OCC database communicates with the OCC component, other program components, and/or the like. The database may contain, retain, and provide information regarding other nodes and data.

### The OCC Component

The OCC component 935 is a stored program component that is executed by a CPU. In one embodiment, the OCC component incorporates any and/or all combinations of the aspects of the OCC that was discussed in the previous figures. As such, the OCC affects accessing, obtaining and the provision of information, services, transactions, and/or the like across various communications networks. The features and embodiments of the OCC discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the OCC features and facilities, and in many cases reduce the costs, energy consumption/requirements, and extend the life of OCC's underlying infrastructure; this has the added benefit of making the OCC more reliable. Similarly, many of the features and mechanisms are designed to be easier for users to use and access, thereby broadening the audience that may enjoy/employ and exploit the feature sets of the OCC; such ease of use also helps to increase the reliability of the OCC. In addition, the feature sets include heightened security as noted via the Cryptographic components 920, 926, 928 and throughout, making access to the features and data more reliable and secure.

The OCC transforms user and/or client system inputs via OCC's verification 942 and extraction 943 components into payment method information outputs.

The OCC component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the OCC server employs a cryptographic server to encrypt and decrypt communications. The OCC component may communicate to and/or with other components in a component collection, including itself, and/or facilities of the like. Most frequently, the OCC component communicates with the OCC database, operating systems, other program components, and/or the like. The OCC may contain, communicate, generate, obtain, and/or provide program component, system, user, and/or data communications, requests, and/or responses.

### Distributed OCC

The structure and/or operation of any of the OCC node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the OCC controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the OCC controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”).

In order to address various issues and advance the art, the entirety of this application (including the Cover Page, Title, Headings, Field, Background, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a OCC individual and/or enterprise user, database configuration and/or relational model, data type, data transmission and/or network framework, syntax structure, and/or the like, various embodiments of the OCC, may be implemented that enable a great deal of flexibility and customization.

What is claimed is:

1. A computer-implemented method for generating a payment user interface, comprising:
receiving, by a computer system operating in accordance with instructions associated with a merchant, a user input;
determining, by the computer system, that the user input reflects a user interest to engage in a payment transaction with the merchant;
determining, by the computer system, a suggested payment method, wherein the suggested payment method is one of the one or more user payment methods registered with the merchant;
retrieving, by the computer system, persisted information associated with the suggested payment method, wherein the persisted information is stored locally on the computer system or remotely on a server associated with the merchant;
determining, by the computer system, that the suggested payment method is registered with a payment service provider;
transmitting, by the computer system, to a server associated with the payment service provider, at least a portion of the persisted information and transaction information associated with the payment transaction;
receiving, by the computer system, from the server one or more responses, which include a risk indicator and payment-service-provider information associated with the suggested payment method;
determining, by the computer system, whether the risk indicator is acceptable; and
generating, by the computer system, a user interface that includes a representation of the suggested payment method using information selected from one or both of the persisted information and the payment-service-provider information, if the risk assessment is determined to be acceptable.

2. The method of claim 1, further comprising:
generating, by the computer system, a second user interface that includes a message rejecting the suggested payment method, if the risk assessment is determined to be unacceptable.

3. The method of claim 1, further comprising:
receiving, by the computer system, a user input indicating a desire to switch to another payment method;
receiving, by the computer system, from the server associated with the payment service provider, information associated with at least some of the one or more user payment methods registered with the merchant;
generating, by the computer system, a second user interface using the received information;
receiving, by the computer system, a user selection of one of the one or more user payment methods;
persisting, by the computer system, the received information associated with the selected payment method; and
persisting, by the computer system, an indication that the selected payment method is a last-used payment method.

4. The method of claim 3, further comprising:
determining, by the computer system, a second suggested payment method based on the persisted indication that the selected payment method is the last-used payment method.

5. The method of claim 1, further comprising:
receiving, by the computer system, a user input indicating a desire to edit the suggested payment method;
receiving, by the computer system, edit information from the user;
updating, by the computer system, the persisted information associated with the suggested payment method using at least a portion of the edit information;
transmitting, by the computer system, at least a portion of the edit information to the server associated with the payment service provider.

6. The method of claim 1, further comprising:
updating, by the computer system, the persisted information based on the payment-service-provider information.

7. The method of claim 1, wherein the computer system is a mobile device and the instructions associated with the merchant is an app.

8. The method of claim 1, wherein the suggested payment method is a credit card and the persisted information includes at least a portion of the credit card's number.

9. The method of claim 1, wherein the transaction information includes a monetary value associated with the payment transaction.

10. The method of claim 1, wherein the suggested payment method is determined based on a transaction history between the user and the merchant.

11. The method of claim 1, wherein the portion of the persisted information transmitted to the server includes an identification associated with the suggested payment method.

12. The method of claim 11, wherein the identification is assigned by the payment service provider.

13. The method of claim 12, wherein the identification is unique to the merchant and to the suggested payment method.

14. A system for generating a payment user interface, comprising:
a processing system; and
a memory coupled to the processing system, wherein the processing system is configured to execute steps, comprising:
receiving, by a computer system operating in accordance with instructions associated with a merchant, a user input;
determining, by the computer system, that the user input reflects a user interest to engage in a payment transaction with the merchant;
determining, by the computer system, a suggested payment method, wherein the suggested payment method is one of the one or more user payment methods registered with the merchant;
retrieving, by the computer system, persisted information associated with the suggested payment method, wherein the persisted information is stored locally on the computer system or remotely on a server associated with the merchant;
determining, by the computer system, that the suggested payment method is registered with a payment service provider;
transmitting, by the computer system, to a server associated with the payment service provider, at least a portion of the persisted information and transaction information associated with the payment transaction;
receiving, by the computer system, from the server one or more responses, which include a risk indicator and payment-service-provider information associated with the suggested payment method;
determining, by the computer system, whether the risk indicator is acceptable; and
generating, by the computer system, a user interface that includes a representation of the suggested payment method using information selected from one or both of the persisted information and the payment-service-provider information, if the risk assessment is determined to be acceptable.

15. The system of claim 14, wherein the processing system is configured to execute further steps, including:
generating, by the computer system, a second user interface that includes a message rejecting the suggested payment method, if the risk assessment is determined to be unacceptable.

16. The system of claim 14, wherein the processing system is configured to execute further steps, including:
receiving, by the computer system, a user input indicating a desire to switch to another payment method;
receiving, by the computer system, from the server associated with the payment service provider, information associated with at least some of the one or more user payment methods registered with the merchant;
generating, by the computer system, a second user interface using the received information;
receiving, by the computer system, a user selection of one of the one or more user payment methods;
persisting, by the computer system, the received information associated with the selected payment method; and
persisting, by the computer system, an indication that the selected payment method is a last-used payment method.

17. The system of claim 16, wherein the processing system is configured to execute further steps, including:
determining, by the computer system, a second suggested payment method based on the persisted indication that the selected payment method is the last-used payment method.

18. The system of claim 14, wherein the processing system is configured to execute further steps, including:
receiving, by the computer system, a user input indicating a desire to edit the suggested payment method;
receiving, by the computer system, edit information from the user;
updating, by the computer system, the persisted information associated with the suggested payment method using at least a portion of the edit information;
transmitting, by the computer system, at least a portion of the edit information to the server associated with the payment service provider.

19. The system of claim 14, wherein the processing system is configured to execute further steps, including:
updating, by the computer system, the persisted information based on the payment-service-provider information.

20. The system of claim 14, wherein the computer system is a mobile device and the instructions associated with the merchant is an application.

21. The system of claim 14, wherein the suggested payment method is a credit card and the persisted information includes at least a portion of the credit card's number.

22. The system of claim 14, wherein the transaction information includes a monetary value associated with the payment transaction.

23. The system of claim 14, wherein the suggested payment method is determined based on a transaction history between the user and the merchant.

24. The system of claim 14, wherein the portion of the persisted information transmitted to the server includes an identification associated with the suggested payment method.

25. The system of claim 24, wherein the identification is assigned by the payment service provider.

26. The system of claim 25, wherein the identification is unique to the merchant and to the suggested payment method.

27. A non-transitory computer-readable medium encoded with instructions for causing a processing system to execute steps for generating a payment user interface, comprising:
receiving, by a computer system operating in accordance with instructions associated with a merchant, a user input;
determining, by the computer system, that the user input reflects a user interest to engage in a payment transaction with the merchant;
determining, by the computer system, a suggested payment method, wherein the suggested payment method is one of the one or more user payment methods registered with the merchant;
retrieving, by the computer system, persisted information associated with the suggested payment method, wherein the persisted information is stored locally on the computer system or remotely on a server associated with the merchant;
determining, by the computer system, that the suggested payment method is registered with a payment service provider;
transmitting, by the computer system, to a server associated with the payment service provider, at least a portion of the persisted information and transaction information associated with the payment transaction;
receiving, by the computer system, from the server one or more responses, which include a risk indicator and payment-service-provider information associated with the suggested payment method;
determining, by the computer system, whether the risk indicator is acceptable; and
generating, by the computer system, a user interface that includes a representation of the suggested payment method using information selected from one or both of the persisted information and the payment-service-provider information, if the risk assessment is determined to be acceptable.

28. The non-transitory computer-readable medium of claim 27, further comprising instructions for causing the processing system to execute steps, including:
generating, by the computer system, a second user interface that includes a message rejecting the suggested payment method, if the risk assessment is determined to be unacceptable.

29. The non-transitory computer-readable medium of claim 27, further comprising instructions for causing the processing system to execute steps, including:
receiving, by the computer system, a user input indicating a desire to switch to another payment method;
receiving, by the computer system, from the server associated with the payment service provider, information associated with at least some of the one or more user payment methods registered with the merchant;
generating, by the computer system, a second user interface using the received information;
receiving, by the computer system, a user selection of one of the one or more user payment methods;
persisting, by the computer system, the received information associated with the selected payment method; and
persisting, by the computer system, an indication that the selected payment method is a last-used payment method.

30. The non-transitory computer-readable medium of claim 29, further comprising instructions for causing the processing system to execute steps, including:
determining, by the computer system, a second suggested payment method based on the persisted indication that the selected payment method is the last-used payment method.

31. The non-transitory computer-readable medium of claim 27, further comprising instructions for causing the processing system to execute steps, including:
receiving, by the computer system, a user input indicating a desire to edit the suggested payment method;
receiving, by the computer system, edit information from the user;
updating, by the computer system, the persisted information associated with the suggested payment method using at least a portion of the edit information;
transmitting, by the computer system, at least a portion of the edit information to the server associated with the payment service provider.

32. The non-transitory computer-readable medium of claim 27, further comprising instructions for causing the processing system to execute steps, including:
updating, by the computer system, the persisted information based on the payment-service-provider information.

33. The non-transitory computer-readable medium of claim 27, wherein the computer system is a mobile device and the instructions associated with the merchant is an app.

34. The non-transitory computer-readable medium of claim 27, wherein the suggested payment method is a credit card and the persisted information includes at least a portion of the credit card's number.

35. The non-transitory computer-readable medium of claim 27, wherein the transaction information includes a monetary value associated with the payment transaction.

36. The non-transitory computer-readable medium of claim 27, wherein the suggested payment method is determined based on a transaction history between the user and the merchant.

37. The non-transitory computer-readable medium of claim 27, wherein the portion of the persisted information transmitted to the server includes an identification associated with the suggested payment method.

38. The non-transitory computer-readable medium of claim 37, wherein the identification is assigned by the payment service provider.

39. The non-transitory computer-readable medium of claim 38, wherein the identification is unique to the merchant and to the suggested payment method.
